(19) United States
(12) Patent Application Publication
(10) Pub. No.: US 2009/0280208 A1
(43) Pub. Date: Nov. 12, 2009

(54) Mold and method for manufacturing mold

(75) Inventors: Wataru Sato, Tochigi (JP); Kazuya Saito, Tochigi (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/387,269

(22) Filed: Apr. 30, 2009

(30) Foreign Application Priority Data
May 8, 2008 (JP) 2008-122166

(51) Int. Cl. B29C 49/48; B05D 3/12

(52) U.S. Cl. 425/522; 427/299

(57) ABSTRACT

Rough machining is performed onto a surface of a base material of a mold. Next, a covering layer whose maximum degree of roughness Ry is 5 to 20 μm is formed on the surface onto which the rough machining has been performed.

### BACKGROUND OF THE INVENTION

1. Field of the Invention

The present invention relates to a mold having a covering layer on its molding surface corresponding to a product surface of a workpiece.

2. Background Art

A mold used in blow molding has an upper mold 101 and a lower mold 102 as shown in FIG. 5A. Inner surfaces of the upper mold 101 and the lower mold 102 form a cavity 103. The upper mold 101 has a gas supply hole 101A, and the lower mold 102 has a gas exhaust hole 102A. The lower mold 102 has a molding surface 104 corresponding to a product surface of a workpiece on the inside thereof, and a covering layer 105 is formed on the molding surface 104. The covering layer 105 is an oxide film obtained by thermal treatment onto the surface of the lower mold 102. A workpiece W is an Al plate which is slidably sandwiched between the upper mold 101 and the lower mold 102.

In blow molding, for example, a mold is heated to set the workpiece W in a high-temperature state, and as shown in FIG. 5B, a gas is supplied into the cavity 103 through the gas supply hole 101A. Thereby, the workpiece W in a high-temperature state is pressed onto the side surface part and the bottom surface part of the molding surface 104 of the lower mold 102 due to its gas pressure, to flow into the cavity 103. Thereby, the workpiece W is molded along the product surface corresponding to the shape of the molding surface 104 of the lower mold 102. In this case, the gas supplied into the cavity 103 is appropriately exhausted through the gas exhaust hole 102A.

However, in the blow molding, the workpiece W adheres to the covering layer 105 of the lower mold 102, and a foreign material such as Al serving as a material of the workpiece W may adhere to the covering layer 105 on the molding surface 104 of the lower mold 102, or the covering layer 105 itself may exfoliate at the time of molding and demolding. Therefore, an uneven shape may be formed on the molding surface 104, and the uneven shape may grow every time molding is performed. As a result, scratches generated on the product surface of the workpiece W become deeper, which leads to the need to restore the product surface.

Then, as disclosed in U.S. Pat. No. 6,655,181, an attempt to improve the smoothness of the molding surface 104 in order to prevent scratches from becoming deeper has been proposed. In detail, a plating process is applied onto the molding surface 104 of the lower mold 102, to form a plating film formed of CrC/NiCr or WC/Co, and polishing is performed onto the plating film. Thereby, an average degree of roughness Ra of the plating film is set to 0.4 to 0.5 μm (a maximum degree of roughness Ry is approximately 1.6 to 2.0 μm). Providing such a plating film serving as the covering layer 105 is an attempt to improve the smoothness of the molding surface 104. In this technology, the workpiece W is prevented from adhering to the lower mold 102, to prevent scratches on the product surface of the workpiece W from becoming deeper.

However, in this case, the smoothness of the molding surface 104 is high, which makes a sliding distance of the workpiece W on the molding surface 104 of the lower mold 102 longer. Thereby, if scratches are generated in the workpiece W, the smoothness makes the scratches longer.

### SUMMARY OF THE INVENTION

One or more embodiments of the invention provide a mold which is capable of shallowing and shortening scratches generated on a product surface of a workpiece W, which makes it easy to restore the product surface of the workpiece W, and to provide a method for manufacturing the mold.

In accordance with one or more embodiments of the invention, a mold is provided with a covering layer on a molding surface corresponding to a product surface of a workpiece, and a maximum degree of roughness Ry of the covering layer is 5 to 20 μm.

According to the embodiments, because the maximum degree of roughness Ry of the covering layer on the molding surface of the mold is set to be greater than or equal to 5 μm, in a blow molding using the mold, it is possible to prevent the workpiece from sliding along the molding surface of the mold. Thereby, even if scratches are generated on the product surface of the workpiece, their lengths can be shortened. Further, because the maximum degree of roughness Ry of the covering layer on the molding surface of the mold is set to be less than or equal to 20 μm, even if scratches are generated on the product surface of the workpiece, the depths of the scratches can be kept at a restorable level. Therefore, it is easy to restore the product surface of the workpiece. Such an advantageous effect can be acquired to a maximum extent by forming the covering layer onto the entire molding surface.

The maximum degree of roughness Ry of the covering layer may be set to 8 to 12 μm. In this aspect, because the maximum degree of roughness Ry is set to be greater than or equal to 8 μm, in the blow molding using the mold, it is possible to further prevent the workpiece from sliding along the molding surface of the mold. Thereby, even if scratches are generated on the product surface of the workpiece, their lengths can be shortened. In addition, because the maximum degree of roughness Ry of the covering layer on the molding surface of the mold is set to be less than or equal to 12 μm, even if scratches are generated on the product surface of the workpiece, the depths of the scratches can be shallowed. Therefore, it is easier to restore the product surface of the workpiece.

Further, a plating layer may be used as a material of the covering layer, and a thickness thereof may be set to be 1 to 50 μm. In this aspect, because the plating layer is used as a material of the covering layer, it is possible to prevent the workpiece from adhering to the mold. Thereby, it is possible to prevent foreign materials from adhering to the covering layer on the molding surface of the mold at the time of molding and demolding, which makes it possible to prevent an uneven shape on the molding surface of the mold from being formed or growing. Accordingly, even if scratches are generated on the product surface of the workpiece, the scratches are shallow, which makes it easier to restore the product surface. In this case, when the thickness of the covering layer is less than 1 μm, the abrasion resistance of the covering layer is insufficient. When the thickness of the covering layer is greater than 50 μm, the covering layer brings about autoclasis.

Accordingly, the thickness of the covering layer is set to be 1 to 50 μm, which makes it possible to ensure abrasion resistance of the covering layer, and prevent autoclasis of the covering layer. Thereby, an uneven shape can be prevented from being formed on the molding surface of the mold, which makes it possible to prevent scratches from being generated on the product surface of the workpiece. As a result, it is easy to restore the product surface of the workpiece.

Moreover, in accordance with one or more embodiments of the invention, a method for manufacturing the mold includes performing rough machining onto a surface of a base material of the mold, and forming a covering layer whose maximum degree of roughness Ry is 5 to 20 μm on the surface onto which the rough machining has been performed.

According to the method for manufacturing the mold of the embodiments, not only the advantageous effects by the mold of the present invention, but also the following advantageous effect can be obtained. That is, because the covering layer is formed on the surface of the base material of the mold after the rough machining onto the surface of the base material of the mold, it is possible to ensure sufficient strength of the covering layer. Because the expansion of the base material of the mold is great at temperatures in blow molding (from a normal temperature to 500° C.), when the covering layer is poor in strength, cracks in the covering layer or exfoliation of the covering layer may occur. However, in the method for manufacturing the mold of the embodiments, it is possible to ensure sufficient strength of the covering layer. Therefore, cracks in the covering layer or exfoliation of the covering layer can be prevented from occurring. Thereby, an uneven shape can be prevented from being formed on the molding surface of the mold, which makes it possible to prevent scratches from being generated on the product surface of the workpiece. As a result, it is easier to restore the product surface of the workpiece.

The maximum degree of roughness Ry of the covering layer maybe set to 8 to 12 μm. Further, plating process may be performed to form the covering layer, and a thickness thereof may be set to be 1 to 50 μm.

In accordance with the mold or the method for manufacturing the mold of the embodiments, because the maximum degree of roughness Ry of the covering layer on the molding surface is set to 5 to 20 μm, even if scratches are generated on the product surface of the workpiece, their lengths can be shortened and the depths of the scratches can be kept at a restorable level. Accordingly, it is easy to restore the product surface of the workpiece.

In accordance with the method for manufacturing the mold of the embodiments, it is a matter of course that the advantageous effects by the mold of the embodiments can be obtained, and cracks in the covering layer or exfoliation of the covering layer can be prevented from occurring. As a result, it is possible to prevent scratches from being generated on the product surface of the workpiece, which makes it easier to restore the product surface of the workpiece.

Other aspects and advantages of the invention will be apparent from the following description, the drawings and the claims.

### BRIEF DESCRIPTION OF THE DRAWINGS

FIGS. 1A to 1C show a method for manufacturing a mold of an exemplary embodiment of the invention, and are side cross sectional views showing partial configurations of the mold in respective processes.

FIG. 2 is a chart showing a relationship between scratch depths on a product surface of a workpiece and restorable levels of the product surface by files in the exemplary embodiment.

FIG. 3 is a graph showing a relationship between scratch depths and scratch lengths on the product surface of the workpiece in the exemplary embodiment.

FIG. 4 is a graph showing a relationship between maximum degrees of roughness Ry on a molding surface of the mold of the exemplary embodiment and scratch lengths on the product surface of the workpiece.

FIGS. 5A and 5B show an example of a schematic configuration of a mold used in blow molding for a workpiece. FIG. 5A is a sectional side view showing a state before the blow molding, and FIG. 5B is a sectional side view showing a state in process of the blow molding.

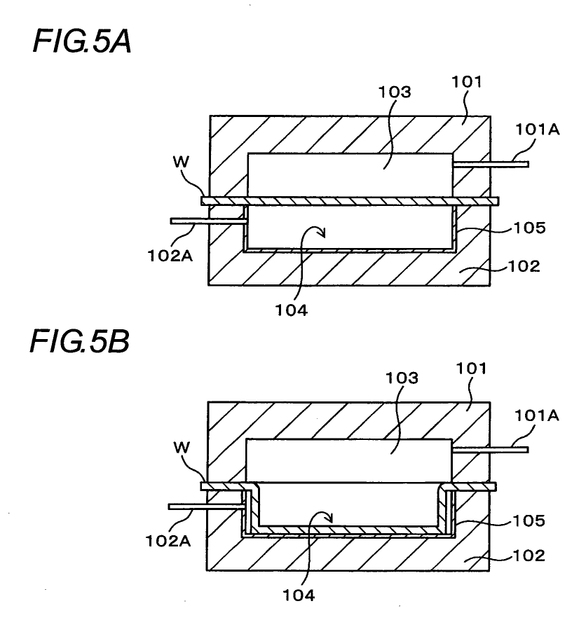

### DETAILED DESCRIPTION OF THE EXEMPLARY EMBODIMENTS

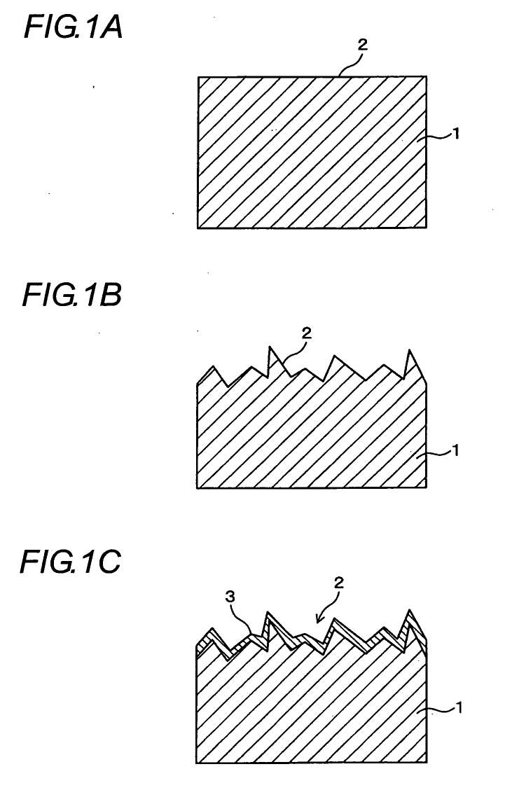

An exemplary embodiment of the invention will be described with reference to drawings. FIGS. 1A to 1C show a method for manufacturing a mold, and a sectional side views of partial configurations of the mold in respective processes. First, as shown in FIG. 1A, a base material of a mold 1 is prepared.

For example, cast steel is used as the base material of the mold 1. Next, as shown in FIG. 1B, rough machining is performed onto a molding surface 2 of the base material of the mold 1.

In this case, for example, blast processing is performed as rough machining such that a maximum degree of roughness Ry on the molding surface 2 of the base material of the mold 1 is set to, for example, 15 to 25 μm.

Next, as shown in FIG. 1C, a covering layer 3 is formed on the molding surface 2 of the base material of the mold 1. For example, Ni—W plating is used as a material of the covering layer 3. Thereby, it is possible to prevent an oxide film from growing on the molding surface. In particular, when a workpiece is formed of an Al material, plating including Ni of the covering layer 3 enables to ensure adhesiveness between the workpiece and the base material of the mold 1. Further, in this case, plating including W of the covering layer 3 causes the mold 1 to be electrically inactive against the Al material in a high-temperature state. A thickness of the covering layer 3 is preferably set to be, for example, 1 to 50 μm. The covering layer 3 is preferably formed onto the entire molding surface 2.

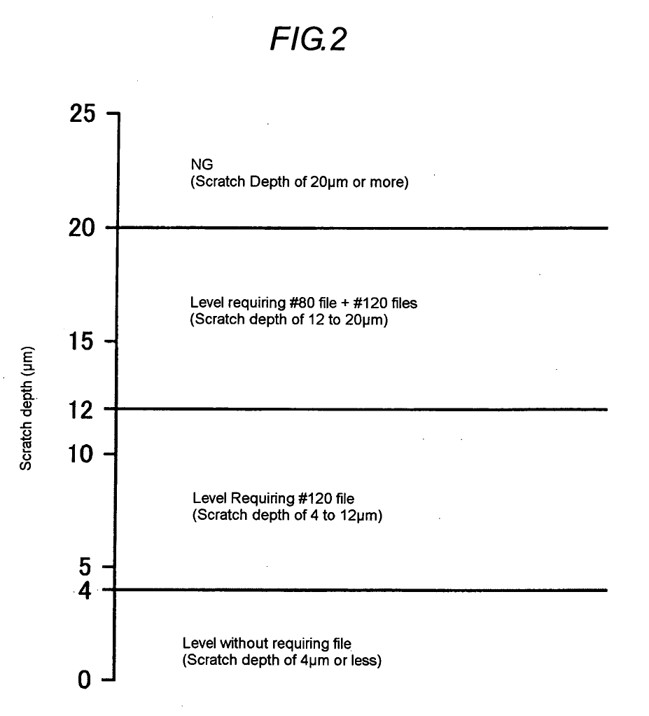

The covering layer 3 as described above is formed onto the molding surface 2 such that the maximum degree of roughness Ry on the molding surface 2 is set to 5 to 20 μm, and more preferably 8 to 12 μm. This will be described with reference to FIGS. 2 to 4.

FIG. 2 is a chart showing a relationship between scratch depths on the product surface of the workpiece and restorable levels of the product surface by files. The data shown in FIG. 2 are obtained from data on depths of scratches generated on the product surface of the workpiece by repeating molding by using molding surfaces of molds having the respective maximum degrees of roughness Ry in order to examine the upper limit of a maximum degree of roughness Ry. As shown in FIG. 2, when a scratch depth is less than or equal to 4 μm, there in no need to restore the product surface of the workpiece (a file is not required). When a scratch depth is 4 to 12 μm, it is necessary to restore the product surface of the workpiece by a file of No. 120. When a scratch depth is 12 to 20 μm, it is necessary to restore the product surface of the workpiece by files of No. 80 and No. 120. When a scratch depth is greater than or equal to 20 μm, it is impossible to restore the product surface of the workpiece by a file (NG).

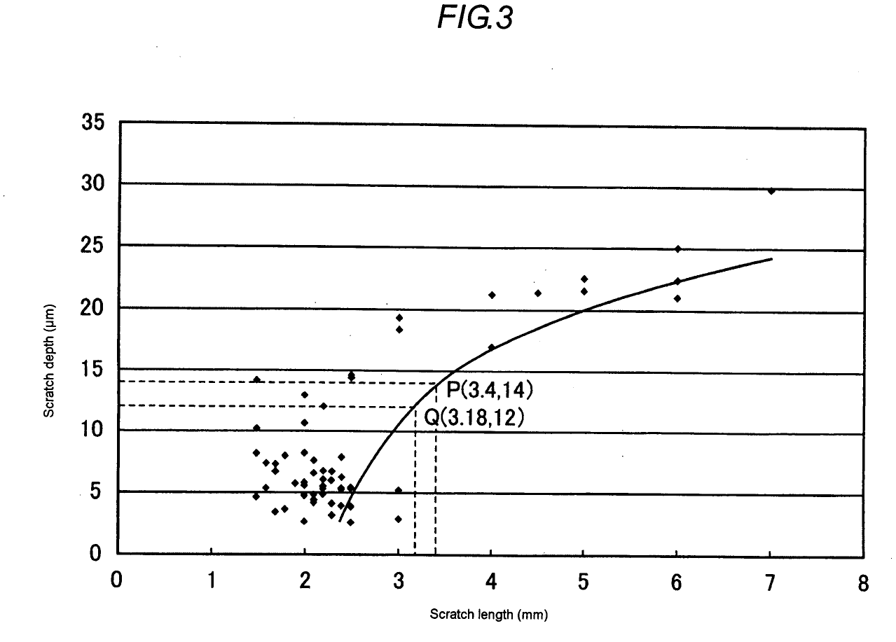

FIG. 3 is a graph showing a relationship between scratch depths and scratch lengths on the product surface of the workpiece of the embodiment according to the present invention. The data (♦ marks) shown in FIG. 3 are data on depths and lengths of scratches generated on the product surface of the workpiece by repeating molding by using molding surfaces of molds in order to examine a lower limit of a maximum degree of roughness Ry, and the relationship among the depths and lengths of the scratches is in a substantially proportional relationship. This is because the longer the scratch (=sliding distance) is, the greater the amount of Al adhering to the mold is, and in a case of mass production, unevenness of a mold grows further.

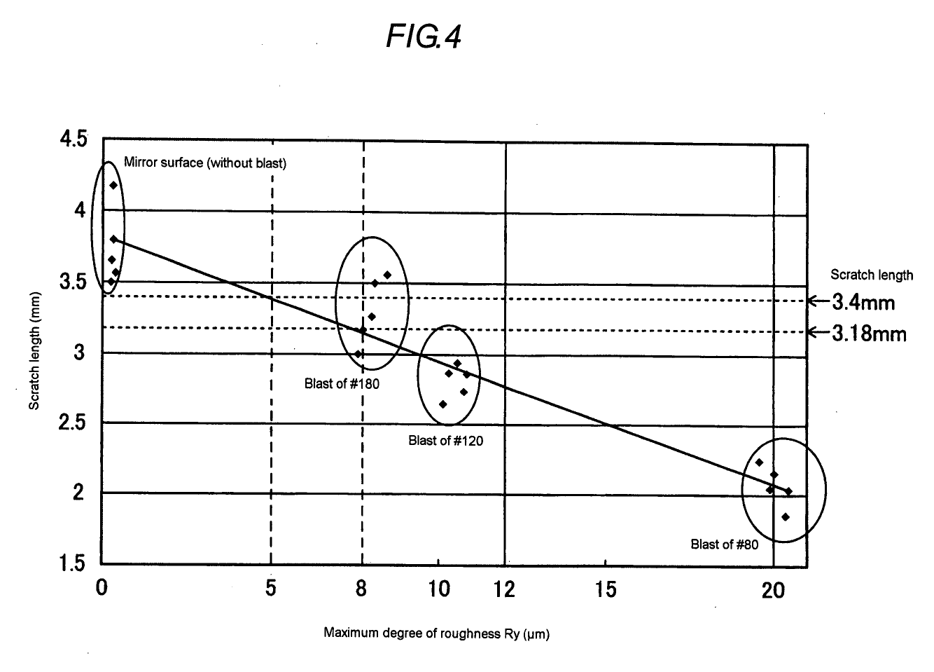

FIG. 4 is a graph showing a relationship between maximum degrees of roughness Ry on the molding surface of the mold of the embodiment according to the present invention and scratch lengths on the product surface of the workpiece. With respect to the data (♦ marks) shown in FIG. 4, a data constellation whose maximum degree of roughness Ry is approximately 0 μm is data on the molding surface of the mold to which blast processing has not been performed (i.e., which is in a mirror surface state) before forming the covering layer, and a data constellation whose maximum degree of roughness Ry is approximately 8 μm is data on the molding surface of the mold to which blast processing at an abrasive particle size of 180 (blast of No. 180) has been performed before forming the covering layer. A data constellation whose maximum degree of roughness Ry is approximately 10 μm is data on the molding surface of the mold to which blast processing at an abrasive particle size of 120 (blast of No. 120) has been performed before forming the covering layer, and a data constellation whose maximum degree of roughness Ry is approximately 20 μm is data on the molding surface of the mold to which blast processing at an abrasive particle size of 80 (blast of No. 80) has been performed before forming the covering layer.

With respect to an upper limit of a maximum degree of roughness Ry on the molding surface of the mold, as shown in FIG. 2, when the maximum degree of roughness Ry is greater than 20 μm, a scratch depth comes to be greater than 20 μm, which makes it impossible to restore the product surface of the workpiece by using a file of No. 80. Accordingly, the maximum degree of roughness Ry is to be less than or equal to 20 μm. Further, as shown in FIGS. 2 and 4, when the maximum degree of roughness Ry is greater than 12 μm, it is necessary to restore the product surface of the workpiece by using files of No. 80 and No. 120. In contrast thereto, when the maximum degree of roughness Ry is set to be less than or equal to 12 μm, only a file of No. 120 is required to restore the product surface of the workpiece. Therefore, the maximum degree of roughness Ry is preferably made to be less than or equal to 12 μm. Further, when a scratch depth is greater than 14 μm, the restoration of the product surface of the workpiece starts to be difficult.

With respect to the lower limit of a maximum degree of roughness Ry on the molding surface of the mold, as shown in FIG. 3, it is necessary to make a scratch length less than or equal to 3.4 mm in order to make the maximum degree of roughness Ry less than or equal to 14 μm that is the maximum allowable range as a scratch depth. As shown in FIG. 4, the maximum degree of roughness Ry corresponding to the range in which a scratch length is less than or equal to 3.4 mm is greater than or equal to 5 μm. Accordingly, the maximum degree of roughness Ry is preferably set to be greater than or equal to 5 μm. Further, as shown in FIG. 3, in order to set a scratch depth to be less than or equal to 12 μm so as to make restorable the product surface of the workpiece by only a file of No. 120, it is necessary to make a scratch length less than or equal to 3.18 mm. As shown in FIG. 4, the maximum degree of roughness Ry corresponding to the range in which a scratch length is less than or equal to 3.18 mm is greater than or equal to 8 μm. Accordingly, the maximum degree of roughness Ry is preferably set to be greater than or equal to 8 μm.

As described above, in the mold 1 of the exemplary embodiment, because the maximum degree of roughness Ry of the covering layer 3 on the molding surface 2 of the mold 1 is set to be greater than or equal to 5 μm, in blow molding using the mold 1, the workpiece is prevented from sliding along the molding surface 2 of the mold 1. Thereby, even if scratches are generated on the product surface of the workpiece, their lengths can be shortened. Further, because the maximum degree of roughness Ry of the covering layer 3 on the molding surface 2 of the mold 1 is set to be less than or equal to 20 μm, even if scratches are generated on the product surface of the workpiece, the depths of the scratches can be kept at a restorable level. Therefore, it is easy to restore the product surface of the workpiece. Such an advantageous effect can be acquired to a maximum extent by forming the covering layer 3 on the entire molding surface 2.

In particular, because the maximum degree of roughness Ry is set to be greater than or equal to 8 μm, in blow molding using the mold 1, it is possible to further prevent the workpiece from sliding along the molding surface 2 of the mold 1. Thereby, even if scratches are generated on the product surface of the workpiece, their lengths can be shortened. Further, because the maximum degree of roughness Ry of the covering layer 3 on the molding surface 2 of the mold 1 is set to be less than or equal to 12 μm, even if scratches are generated on the product surface of the workpiece, the depths of the scratches can be shallowed. Therefore, it is easier to restore the product surface of the workpiece.

Further, because the plating is used as a material of the covering layer 3, the workpiece can be prevented from adhering to the mold 1. Thereby, foreign materials can be prevented from adhering to the covering layer 3 on the molding surface 2 of the mold 1 at the time of molding and demolding, which makes it possible to prevent an uneven shape on the molding surface 2 of the mold 1 from being formed or growing. Accordingly, even if scratches are generated on the product surface of the workpiece, the scratches are shallow, which makes it easier to restore the product surface. In this case, when the thickness of the covering layer 3 is less than 1 μm, the abrasion resistance of the covering layer 3 is insufficient. When the thickness of the covering layer 3 is greater than 50 μm, the covering layer 3 brings about autoclasis. Accordingly, provided that the thickness of the covering layer 3 is set to be 1 to 50 μm, it is possible to ensure abrasion resistance of the covering layer 3, and prevent autoclasis of the covering layer 3. Thereby, the molding surface 2 of the mold 1 can be prevented from forming an uneven shape thereon, which makes it possible to prevent scratches from being generated on the product surface of the workpiece. As a result, it is easy to restore the product surface of the workpiece.

The method for manufacturing the mold 1 of the exemplary embodiment can obtain, not only the advantageous effects by the mold 1 of the present embodiment, but also the following advantageous effect. That is, because the covering layer 3 is formed on the surface of the base material of the mold 1 after the rough machining onto the surface of the base material of the mold 1, it is possible to ensure sufficient strength of the covering layer 3. Because expansion of the base material of the mold 1 is great at temperatures in blow molding (from a normal temperature to 500° C.), when the covering layer 3 is poor in strength, cracks in the covering layer 3 or exfoliation of the covering layer 3 may occur. However, in the method for manufacturing the mold 1 of the present embodiment, it is possible to ensure sufficient strength of the covering layer 3. Therefore, it is possible to prevent cracks in the covering layer 3 or exfoliation of the covering layer 3 from occurring. Thereby, the molding surface 2 of the mold 1 can be prevented from forming an uneven shape thereon, which makes it possible to prevent scratches from being generated on the product surface of the workpiece. As a result, it is easier to restore the product surface of the workpiece.

While description has been made in connection with specific exemplary embodiment of the invention, it will be obvious to those skilled in the art that various changes and modification may be made therein without departing from the present invention. It is aimed, therefore, to cover in the appended claims all such changes and modifications falling within the true spirit and scope of the present invention.

1. A mold comprising:
a covering layer on a molding surface corresponding to a product surface of a workpiece, wherein a maximum degree of roughness Ry of the covering layer is 5 to 20 μm.

2. The mold according to claim 1, wherein the maximum degree of roughness Ry of the covering layer is 8 to 12 μm.

3. The mold according to claim 1, wherein the covering layer comprises a plating layer, and a thickness of the covering layer is 1 to 50 μm.

4. A method for manufacturing a mold comprising:
performing rough machining onto a surface of a base material of the mold; and
forming a covering layer whose maximum degree of roughness Ry is 5 to 20 μm.

5. The method according to claim 4, further comprising:
setting the maximum degree of roughness Ry of the covering layer to 8 to 12 μm.

6. The method according to claim 4, further comprising:
performing a plating process to form the covering layer; and
setting a thickness of the covering layer to 1 to 50 μm.

7. The mold according to claim 2, wherein the covering layer comprises a plating layer, and a thickness of the covering layer is 1 to 50 μm.
